(19) United States
(12) Patent Application Publication
(10) Pub. No.: US 2026/0205915 A1
(43) Pub. Date: Jul. 16, 2026

(54) IN-VEHICLE DEVICE

(71) Applicant: TOYOTA JIDOSHA KABUSHIKI KAISHA, Toyota-shi (JP)

(72) Inventors: Noriaki ITO, Toyota-chi (JP); Shingo Sugimoto, Nagoya-shi (JP); Yuma Ito, Chiryu-shi (JP)

(73) Assignee: TOYOTA JIDOSHA KABUSHIKI KAISHA, Toyota-shi (JP)

(21) Appl. No.: 19/411,601

(22) Filed: Dec. 8, 2025

(30) Foreign Application Priority Data
Jan. 14, 2025 (JP) 2025-005011

(51) Int. Cl. H04W 36/32

(52) U.S. Cl. CPC H04W 36/324; H04W 36/322; H04W 36/326

(57) ABSTRACT

The in-vehicle device includes a communication unit and a control unit. When the communication unit is connected to the communication device by a wireless LAN, the control unit determines whether or not to switch the connection destination of the communication unit to another communication device based on at least one of the absolute speed of the vehicle, the travel distance of the vehicle, and the relative speed of the vehicle with respect to the communication device.

### CROSS-REFERENCE TO RELATED APPLICATION

This application claims priority to Japanese Patent Application No. 2025-005011 filed on January 14, 2025. The disclosure of the above-identified application, including the specification, drawings, and claims, is incorporated by reference herein in its entirety.

### BACKGROUND

### Technical Field

The present disclosure relates to an in-vehicle device.

### Description of Related Art

Conventionally, there is known a technique of selecting a desired network interface, from a plurality of network interfaces for communication between a plurality of vehicles, based on a wireless measurement score (Japanese Unexamined Patent Application Publication No. 2022-159229 (JP 2022-159229 A)).

### SUMMARY

In order to configure a mesh network such as a Wi-Fi (registered trademark) mesh, a communication device of a vehicle is connected to a different communication device. However, there is a possibility that when the absolute speed of the vehicle changes, the vehicle moves, or the relative speed of the vehicle with respect to a different vehicle changes, the quality of communication between the communication device of the vehicle and the different communication device deteriorates.

In view of the foregoing, an object of the present disclosure is to provide a technique of maintaining more stable communication in a vehicle.

An aspect of the present disclosure provides an in-vehicle device including: a communication unit; and a control unit that, when the communication unit is connected to a communication device through a wireless local area network (LAN), determines whether to switch a connection destination of the communication unit to a different communication device based on at least one of an absolute speed of a vehicle, a moving distance of the vehicle, and a relative speed of the vehicle with respect to the communication device, in which the control unit is configured to: when an absolute speed of the communication device is zero, acquire data on the absolute speed of the vehicle, and when the acquired absolute speed of the vehicle is equal to or more than an absolute speed threshold, determine to switch the connection destination of the communication unit to the different communication device; when the communication device is a communication device mounted on a different vehicle, calculate a relative speed of the vehicle with respect to the different vehicle as the relative speed of the vehicle with respect to the communication device, and when the calculated relative speed of the vehicle is equal to or more than a relative speed threshold, determine to switch the connection destination of the communication unit to the different communication device; or when the absolute speed of the communication device is zero, acquire data on the moving distance of the vehicle from the communication device, and when the acquired moving distance of the vehicle is equal to or more than a distance threshold, determine to switch the connection destination of the communication unit to the different communication device.

An aspect of the present disclosure provides an in-vehicle device including: a communication unit; and a control unit that, when the communication unit is connected to a communication device through a wireless local area network (LAN), determines whether to switch a connection destination of the communication unit to a different communication device based on at least one of an absolute speed of a vehicle, a moving distance of the vehicle, and a relative speed of the vehicle with respect to the communication device.

According to an embodiment of the present disclosure, it is possible to maintain more stable communication in a vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block-diagram illustrating a schematic configuration of a vehicle according to an embodiment of the present disclosure; and

FIG. 2 is a flowchart illustrating an example of an operation of the in-vehicle device illustrated in FIG. 1.

### DETAILED DESCRIPTION OF EMBODIMENTS

Hereinafter, an embodiment of the present disclosure will be described below with reference to the drawings.

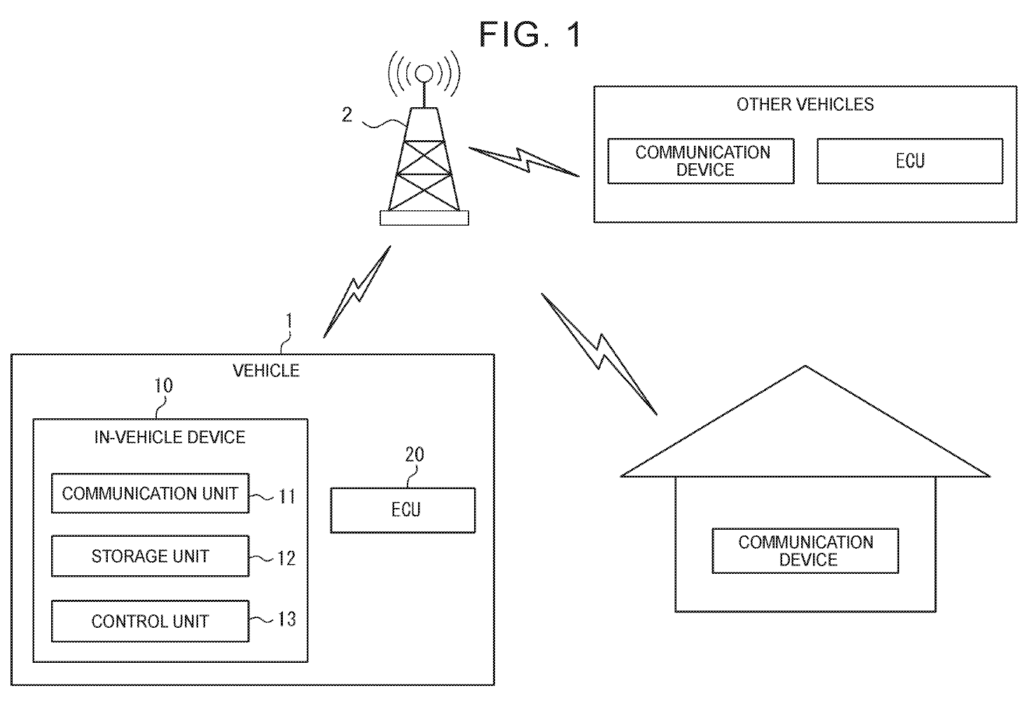

As illustrated in FIG. 1, a vehicle 1 according to the present embodiment includes an in-vehicle device 10 and an electronic control unit (ECU: Electronic Control Unit) 20. The in-vehicle device 10 is, for example, a communication device. The electronic control unit 20 controls various devices such as an engine of the vehicle 1. The vehicle 1 may comprise a plurality of electronic control units 20. The vehicle 1 can be connected to a communication device outside the vehicle by a wireless LAN by the in-vehicle device 10. The vehicle 1 is connected to a communication device outside the vehicle by a wireless LAN by the in-vehicle device 10, and thus can become a node of a mesh network by wireless LAN. A standard of the wireless LAN according to the present embodiment is, for example, Wi-Fi. The in-vehicle device 10 includes a communication unit 11, a storage unit 12, and a control unit 13. The communication unit 11 is configured to include a first communication module compliant with a standard of a wireless LAN such as Wi-Fi, and a second communication module connectable to the mobile communication network 2. The second communication module is, for example, a communication module compatible with a mobile communication standard such as 4G or 5G. The storage unit 12 includes at least one semiconductor memory or the like. The storage unit 12 stores data used for the operation of the in-vehicle device 10 and data obtained by the operation of the in-vehicle device 10. The storage unit 12 may store a program to be executed by the control unit 13. The control unit 13 includes at least one processor. The processor is, for example, a general-purpose processor such as a CPU or a special-purpose processor specialized for a particular process. The control unit 13 executes processing related to the operation of the in-vehicle device 10 while controlling each unit of the in-vehicle device 10.

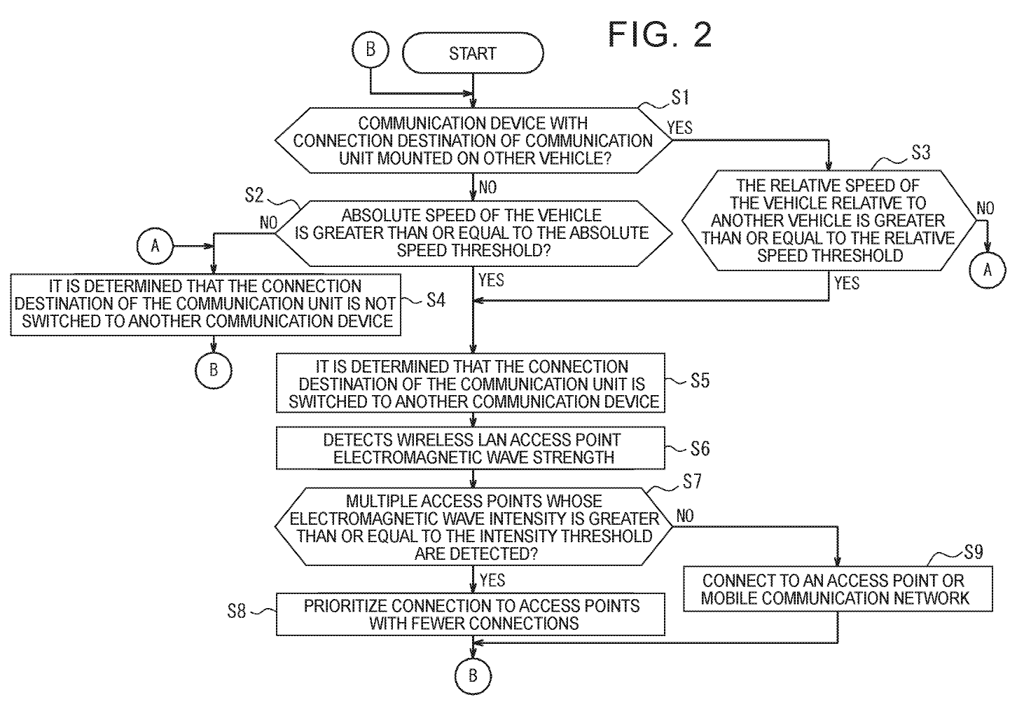

FIG. 2 is a flowchart illustrating an example of the operation of the in-vehicle device 10 illustrated in FIG. 1. When the communication unit 11 is connected to the communication device via a wireless LAN, the control unit 13 of the in-vehicle device 10 starts S1 process. Hereinafter, a communication device to which the communication unit 11 is connected via a wireless LAN is referred to as a connection destination of the communication unit 11. The control unit 13 may execute the processing illustrated in FIG. 2 while monitoring the communication quality between the communication unit 11 and the connection destination, or may execute the processing illustrated in FIG. 2 without monitoring the communication quality between the communication unit 11 and the connection destination.

In S1, the control unit 13 determines whether the connection destination of the communication unit 11 is a communication device mounted on another vehicle (S1: YES) or a communication device not mounted on another vehicle (S1: NO). Since a communication device not mounted on another vehicle is not mounted on another vehicle, its position does not move. Therefore, a communication device that is not mounted in another vehicle can be referred to as a communication device in which the absolute speed of the communication device is zero. That is, S1 can also be referred to as a process in which the control unit 13 determines whether the connection destination of the communication unit 11 is a communication device mounted on another vehicle (S1: YES) or whether the connection destination of the communication unit 11 is a communication device whose absolute velocity is zero (S1: NO). The communication device not mounted on the other vehicle may be any communication device such as a communication device installed in the home of the user of the vehicle 1 or a communication device providing a public wireless LAN. Communication devices providing public wireless LAN include so-called Wi-Fi spots. For example, when the vehicle 1 stands by at home or is near home, the connection destination of the communication unit 11 is a communication device installed in the home of the user of the vehicle 1. When the vehicle 1 is stopped, the communication unit 11 is connected to a communication device or the like that provides a public wireless LAN. Here, in a case where the connection destination of the communication unit 11 is a communication device mounted on another vehicle, the control unit 13 can execute the communication device of the other vehicle and the inter-vehicle communication by the communication unit 11. Therefore, the control unit 13 may determine that the connection destination of the communication unit 11 is a communication device mounted on another vehicle by executing the vehicle-to-vehicle communication with the communication device of the other vehicle by the communication unit 11. In a case where the communication device of the connection destination of the communication unit 11 cannot be identified by the inter-vehicle communication performed by the communication unit 11, the control unit 13 may determine that the connection destination of the communication unit 11 is a communication device that is not mounted on another vehicle. In addition, the control unit 13 may determine whether the connection destination is a communication device mounted on another vehicle or a communication device not mounted on another vehicle according to SSID (Service Set Identifier) of the connection destination of the communication unit 11. When the control unit 13 determines that the destination of the communication unit 11 is a communication device that is not mounted on another vehicle (S1: NO), S2 proceeds. When the control unit 13 determines that the destination of the communication unit 11 is a communication device mounted on another vehicle (S1: YES), S3 proceeds.

In S2, the control unit 13 communicates with the electronic control unit 20 to acquire the absolute velocity of the vehicle 1. The control unit 13 determines whether or not the absolute speed of the vehicle 1 is equal to or greater than an absolute speed threshold. Absolute velocity thresholds may be set based on the extent to which electromagnetic waves of a typical wireless LAN reach. The absolute velocity thresholds are, for example, 8 km/h. When the control unit 13 determines that the absolute speed of the vehicle 1 is equal to or greater than the absolute speed threshold (S2: YES), the process proceeds to S5. When the control unit 13 determines that the absolute speed of the vehicle 1 is lower than the absolute speed threshold (S2: NO), the process proceeds to S4.

In S3, the control unit 13 acquires the absolute velocity of the other vehicle by executing the vehicle-to-vehicle communication with the communication device of the other vehicle by the communication unit 11. In addition, the control unit 13 acquires data of the absolute speed of the vehicle 1 by communicating with the electronic control unit 20. The control unit 13 calculates the relative speed of the vehicle 1 with respect to the other vehicle on which the communication device is mounted, as the relative speed of the vehicle 1 with respect to the communication device that is the connection destination of the communication unit 11, based on the data. The control unit 13 determines whether or not the relative speed of the vehicle 1 with respect to the communication device that is the connection destination of the communication unit 11, that is, the relative speed of the vehicle 1 with respect to the other vehicle, is equal to or higher than the relative speed threshold. The relative-velocity thresholds may be set based on the extent to which electromagnetic waves of a typical wireless LAN reach. When the control unit 13 determines that the relative speed of the vehicle 1 with respect to the other vehicle is equal to or higher than the relative speed threshold (S3: YES), S5 proceeds. When the control unit 13 determines that the relative speed of the vehicle 1 with respect to the other vehicle is lower than the relative speed threshold (S3: NO), S4 proceeds.

In S4, the control unit 13 determines that the connection destination of the communication unit 11 is not switched to another communication device. After S4 process, the control unit 13 returns to S1. In S5, the control unit 13 determines to switch the connection destination of the communication unit 11 to another connection device. In S6, the control unit 13 detects the electromagnetic wave strength of the access point of the wireless LAN around the vehicle 1 by the communication unit 11. The access point is a communication device that transmits and receives electromagnetic waves of a wireless LAN. In S7, the control unit 15 determines whether or not a plurality of access points whose electromagnetic wave intensities are equal to or greater than the intensity thresholds are detected based on the detection result of the electromagnetic wave intensities of S6. The intensity threshold may be set in accordance with the use state of the communication unit 11. When the control unit 13 determines that a plurality of access points whose electromagnetic wave intensity is equal to or greater than the intensity threshold are detected (S7: YES), the process proceeds to S8. When it is not determined that a plurality of access points having the electromagnetic wave intensity equal to or greater than the intensity threshold are detected (S7: NO), the control unit 13 proceeds to S9.

In S8, the control unit 13 preferentially connects the communication unit 11 to an access point having a small number of connections among a plurality of access points having an electromagnetic wave intensity equal to or greater than an intensity threshold. The number of access points connected is the number of devices connected to the access point. The control unit 13 may acquire the information on the number of connections of the access point by receiving the information from the server or the like via the mobile communication network 2 or the like by the communication unit 11. In order to preferentially connect to an access point having a small number of connections, the control unit 13 may connect the communication unit 11 to an access point having the smallest number of connections among a plurality of access points having an electromagnetic wave intensity equal to or greater than an intensity threshold. Alternatively, among the plurality of access points having the electromagnetic wave intensity equal to or higher than the intensity threshold, a plurality of access points having a smaller number of connections than a predetermined number may be included. In this case, the control unit 13 may connect the communication unit 11 to an access point having the strongest electromagnetic wave intensity among a plurality of access points having the number of connections smaller than a predetermined number. The predetermined number may be set according to the use state of the communication unit 11. After S8 process, the control unit 13 returns to S1.

In S9, the control unit 13 connects the communication unit 11 to the access point having the strongest electromagnetic wave intensity based on the detected electromagnetic wave intensity of S6. Alternatively, the control unit 13 may connect the communication unit 11 to the mobile communication network 2, for example, in a case where there is no access point whose electromagnetic wave intensity is equal to or higher than the lower limit threshold around the vehicle 1. The lower limit threshold may be set in accordance with the use state of the communication unit 11. Alternatively, the control unit 13 may simply connect the communication unit 11 to another communication device. After S9 process, the control unit 13 returns to S1.

### Other examples

As another example, the control unit 13 may transmit, by the communication unit 11, a transmission request for data of the absolute speed of the connection destination of the communication unit 11 to the connection destination of the communication unit 11. In this case, the control unit 13 receives, by the communication unit 11, data of the absolute speed of the connection destination of the communication unit 11 from the connection destination of the communication unit 11. The control unit 13 calculates the relative speed of the vehicle 1 with respect to the connection destination of the communication unit 11 based on the data of the absolute speed of the connection destination of the communication unit 11 and the data of the absolute speed of the vehicle 1. When the control unit 13 determines that the calculated relative velocity of the vehicle 1 is equal to or greater than the threshold value, S5 proceeds. When the control unit 13 determines that the calculated relative velocity of the vehicle 1 is lower than the threshold value, S4 proceeds. The thresholds may be set based on the extent to which electromagnetic waves of a typical wireless LAN reach. The threshold may be the same as or different from the relative speed threshold.

### Another case 1 of S2

In the first embodiment of S2, the control unit 13 communicates with the electronic control unit 20 to acquire the travel distance of the vehicle 1 from the destination to which the communication unit 11 is connected. The control unit 13 may calculate the data of the travel distance of the vehicle 1 from the connection destination of the communication unit 11 based on the timing or the like at which the communication unit 11 is connected to the connection destination. The control unit 13 determines whether or not the moving distance of the vehicle 1 from the connection destination of the communication unit 11 is equal to or greater than a distance threshold value. The distance-threshold value may be set based on a range in which electromagnetic waves of a typical wireless LAN reach. When the coverage of a typical wireless LAN is 100 m, the range thresholds are, for example, 50 m. When it is determined that the moving distance of the vehicle 1 from the connection destination of the communication unit 11 is equal to or larger than the distance threshold (S2: YES), the control unit 13 proceeds to S5. When the control unit 13 determines that the moving distance of the vehicle 1 from the connection destination of the communication unit 11 is less than the distance threshold (S2: NO), S4 proceeds.

### Other cases of S2 2

In another embodiment 2 of S2, the control unit 13 determines whether or not the absolute speed of the vehicle 1 is equal to or greater than the absolute speed threshold, the same as or similar to the above S2. The absolute velocity threshold according to another second embodiment of S2 may be the same as or set separately from the absolute velocity threshold according to S2. Similar to the above S2, when the control unit 13 determines that the absolute speed of the vehicle 1 is lower than the absolute speed threshold, S4 proceeds. However, in another example 2 of S2, when the control unit 13 determines that the absolute speed of the vehicle 1 is equal to or greater than the absolute speed threshold, the control unit 13 determines whether or not the moving distance of the vehicle 1 from the connection destination of the communication unit 11 is equal to or greater than the distance threshold in the same or similar manner as in the other example 1 of the above S2. The distance threshold value according to another example 2 of S2 may be the same as the distance threshold value according to another example 1 of S2, or may be set separately. When determining that the moving distance of the vehicle 1 from the connection destination of the communication unit 11 is equal to or greater than the distance threshold, the control unit 13 proceeds to S5. When the control unit 13 determines that the moving distance of the vehicle 1 from the connection destination of the communication unit 11 is less than the distance threshold, S4 proceeds.

### Another case 1 of S3

In another embodiment 1 of S3, the control unit 13 determines whether or not the absolute speed of the vehicle 1 is equal to or greater than the absolute speed threshold, the same as or similar to the above-described S2. The absolute speed threshold value according to another embodiment 1 of S3 may be the same as the absolute speed threshold value according to S2, or may be set separately. Similar to the above S2, when the control unit 13 determines that the absolute speed of the vehicle 1 is lower than the absolute speed threshold, S4 proceeds. However, in the first embodiment of S3, when determining that the absolute speed of the vehicle 1 is equal to or greater than the absolute speed threshold, the control unit 13 determines whether or not the relative speed of the vehicle 1 with respect to the other vehicle is equal to or greater than the relative speed threshold, the same as or similar to the above-described S3. The other vehicle is a vehicle on which the communication device to which the communication unit 11 is connected is mounted as in S3. The relative velocity threshold according to another embodiment of S3 may be the same as or set separately from the relative velocity threshold according to S3. When the control unit 13 determines that the relative speed of the vehicle 1 with respect to the other vehicle is equal to or higher than the relative speed threshold, S5 proceeds. When determining that the relative speed of the vehicle 1 with respect to the other vehicle is lower than the relative speed threshold, the control unit 13 proceeds to S4.

As described above, in the in-vehicle device 10 according to the present embodiment, the control unit 13 determines whether or not to switch the connection destination of the communication unit to another communication device based on at least one of the following: the absolute speed of the vehicle 1; the moving distance of and vehicle 1; and the relative speed of the vehicle 1 with respect to the communication device. In the in-vehicle device 10, it is determined whether or not to switch the connection destination of the communication unit 11 when the communication unit 11 is connected to the communication device by a wireless LAN. Therefore, in the in-vehicle device 10, the connection destination of the communication unit 11 can be switched to another communication device before the communication quality between the communication unit 11 and the connection destination of the communication unit 11 deteriorates. With such a configuration, it is possible to keep the communication quality in the vehicle 1 constant. Therefore, according to the present embodiment, it is possible to maintain more stable communication in the vehicle 1.

Further, in the present embodiment, when the absolute speed of the connection destination of the communication unit 11 is zero, the control unit 13 may determine to switch the connection destination of the communication unit 11 to another communication device when the absolute speed of the vehicle 1 is equal to or greater than the absolute speed threshold. Here, in many cases, the communication unit 11 is connected to a communication device such as a home while the vehicle 1 is waiting at home or the like. In addition, while the vehicles 1 are stopped, the communication unit 11 is often connected to a communication device that provides a public wireless LAN. In such a case, when the vehicle 1 starts moving, when the communication unit 11 remains connected to a communication device such as a home, the communication quality in the vehicle 1 deteriorates or the communication in the vehicle 1 is interrupted. In the present embodiment, the control unit 13 determines to switch the connection destination of the communication unit 11 to another communication device when the absolute speed of the vehicle 1 is equal to or higher than the absolute speed threshold. Therefore, it is possible to switch the connection destination of the communication unit 11 from a communication device such as a home to another communication device before the communication quality in the vehicle 1 deteriorates. With such a configuration, the communication unit 11 remains connected to a communication device such as a home, and it is possible to suppress the communication quality of the vehicle 1 deteriorating or the communication of the vehicle 1 being interrupted.

Further, in the present embodiment, when the communication device of the connection destination of the communication unit 11 is a communication device mounted on another vehicle, the control unit 13 may determine as follows. Specifically, when the relative speed of the vehicle 1 with respect to the other vehicle is equal to or higher than the relative speed threshold, the control unit 13 may determine to switch the connection destination of the communication unit 11 to the other connection destination. With such a configuration, as will be described below, it is possible to more appropriately determine whether or not to switch the connection destination of the communication unit 11. For example, even when the vehicle 1 is moving at a high speed, when the relative speed of the vehicle with respect to the other vehicle is close to zero because the other vehicle is also moving at a high speed, the communication quality between the vehicle 1 and the other vehicle is not deteriorated. In this case, since the relative speed of the vehicle 1 with respect to the other vehicle is lower than the relative speed threshold, the connection destination of the communication unit 11 is not switched to the other communication device. As a result, communication between the vehicle 1 and other vehicles can be maintained. Further, when one of the vehicle 1 and the other vehicle stops or the other vehicle moves to the side opposite to the vehicle 1, the communication quality between the vehicle 1 and the other vehicle deteriorates. In this case, since the relative speed of the vehicle 1 with respect to the other vehicle is equal to or higher than the relative speed threshold, the connection destination of the communication unit 11 can be switched to the other communication device.

In the present embodiment, the control unit 13 may determine the connection destination of the communication unit 11 as follows when an access point of a plurality of wireless LAN whose electromagnetic wave strength is equal to or greater than the strength threshold is detected. Specifically, the communication unit 11 may be preferentially connected to an access point having a small number of connections among the plurality of access points. For example, when the other vehicle on which the communication device is mounted comes close to the vehicle 1, it is assumed that the electromagnetic wave intensity of the communication device of the other vehicle detected in the vehicle 1 becomes strong. However, in a case where a large number of devices are connected to the communication device of the other vehicle, it is assumed that the communication quality of the vehicle deteriorates even when the connection destination of the communication unit 11 is switched to the communication device of the other vehicle. On the other hand, even in the case of another vehicle whose distance from the vehicle 1 is a little, when the number of other devices connected to the communication device of the vehicle is small, when the connection destination of the communication unit 11 is switched to the communication device of the other vehicle, it is assumed that the communication quality in the vehicle 1 is stable. Since the communication unit 11 is preferentially connected to an access point having a small number of connections among a plurality of access points, the communication quality in the vehicle 1 can be stabilized.

Further, in the present embodiment, when the control unit 13 determines to switch the connection destination of the communication unit 11 to another communication device, the communication unit 11 may be connected to the mobile communication network 2. By connecting the communication unit 11 to the mobile communication network 2, it is possible to stabilize the communication quality in the vehicle 1.

Although the present disclosure has been described above based on the drawings and the embodiment, it should be noted that those skilled in the art may make various modifications and alterations thereto based on the present disclosure. It should be noted, therefore, that these modifications and alterations are within the scope of the present disclosure. For example, the functions included in the configurations, steps, etc. can be rearranged so as not to be logically inconsistent, and a plurality of configurations, steps, etc. can be combined into one or divided.

What is claimed is:

1. An in-vehicle device comprising:
a communication unit; and
a control unit that, when the communication unit is connected to a communication device through a wireless local area network (LAN), determines whether to switch a connection destination of the communication unit to a different communication device based on at least one of an absolute speed of a vehicle, a moving distance of the vehicle, and a relative speed of the vehicle with respect to the communication device, wherein
the control unit is configured to:
when an absolute speed of the communication device is zero, acquire data on the absolute speed of the vehicle, and when the acquired absolute speed of the vehicle is equal to or more than an absolute speed threshold, determine to switch the connection destination of the communication unit to the different communication device;
when the communication device is a communication device mounted on a different vehicle, calculate a relative speed of the vehicle with respect to the different vehicle as the relative speed of the vehicle with respect to the communication device, and when the calculated relative speed of the vehicle is equal to or more than a relative speed threshold, determine to switch the connection destination of the communication unit to the different communication device; or
when the absolute speed of the communication device is zero, acquire data on the moving distance of the vehicle from the communication device, and when the acquired moving distance of the vehicle is equal to or more than a distance threshold, determine to switch the connection destination of the communication unit to the different communication device.

2. An in-vehicle device comprising:
a communication unit; and
a control unit that, when the communication unit is connected to a communication device through a wireless local area network (LAN), determines whether to switch a connection destination of the communication unit to a different communication device based on at least one of an absolute speed of a vehicle, a moving distance of the vehicle, and a relative speed of the vehicle with respect to the communication device.

3. The in-vehicle device according to claim 2, wherein when an absolute speed of the communication device is zero, the control unit determines to switch the connection destination of the communication unit to the different communication device when the absolute speed of the vehicle is equal to or more than an absolute speed threshold.

4. The in-vehicle device according to claim 2, wherein when the communication device is a communication device mounted on a different vehicle, the control unit acquires a relative speed of the vehicle with respect to the different vehicle as the relative speed of the vehicle with respect to the communication device, and when the acquired relative speed of the vehicle with respect to the different vehicle is equal to or more than a relative speed threshold, determines to switch the connection destination of the communication unit to the different communication device.

5. The in-vehicle device according to claim 2, wherein when it is determined to switch the connection destination of the communication unit to the different communication device, and when a plurality of wireless LAN access points whose electromagnetic wave intensity is equal to or more than an intensity threshold is detected, the control unit preferentially connects the communication unit to an access point with a smaller number of connections, among the access points.

6. The in-vehicle device according to claim 2, wherein when it is determined to switch the connection destination of the communication unit to the different communication device, the control unit connects the communication unit to a mobile communication network.
